(19) United States
(12) Patent Application Publication
(10) Pub. No.: US 2009/0262898 A1
(43) Pub. Date: Oct. 22, 2009

(54) INFORMATION PROCESSING APPARATUS CAPABLE OF CHANGING SELECTION ORDER AND METHOD FOR CONTROLLING THE SAME

(75) Inventors: Hiroyuki Matsuno, Shimotsuke-shi (JP); Keisuke Arima, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/427,600

(22) Filed: Apr. 21, 2009

(30) Foreign Application Priority Data
Apr. 22, 2008 (JP) 2008-111516

(51) Int. Cl. H05G 1/58; G06F 3/048

(52) U.S. Cl. 378/116; 715/764

(57) ABSTRACT

An information processing apparatus includes an evaluation unit configured to obtain priority of each arranged component according to attribute information given to the arranged component and a determination unit configured to obtain an order used for selecting the arranged component according to the result of the evaluation of the evaluation unit.

### BACKGROUND OF THE INVENTION

1. Field of the Invention

The present invention relates to an information processing apparatus capable of changing a selection order, a control method, a program, and a storage medium. More particularly, the present invention relates to an information processing system configured to determine an input order of an information processing apparatus capable of changing a screen layout.

2. Description of the Related Art

In recent years, X-ray imaging apparatuses used for medical diagnosis as an example of information processing apparatuses include an apparatus that reads out an image signal from a photostimulable phosphor plate or a digital X-ray imaging apparatus that includes a flat panel detector (FPD). The FPD converts X-ray energy into an electric signal in proportion to the strength of the X-ray energy. By using the digital X-ray imaging apparatus including the FPD, an image can be confirmed immediately after it is taken. Thus, whether the imaging has been successfully taken can be determined directly after the imaging. This eliminates the need for developing film and reading out an image from the photostimulable phosphor plate. As a result, an order for imaging can be performed quickly and thus imaging efficiency is improved for a user of the X-ray imaging apparatus such as a radiological technologist.

Generally, in using the X-ray imaging apparatus, various information on the subject is input at the time of imaging and stored in association with the X-ray image that is taken. Such information includes, for example, patient information, X-ray imaging procedure, X-ray imaging portion, X-ray imaging condition, and image processing condition. Simplification of the setting is required accordingly.

Usually, information to be entered by the user when the X-ray imaging is performed, screen configuration, and input order depend on a manufacturer of the apparatus. Since an input screen of the X-ray imaging apparatus includes many input items, a user who is accustomed to a certain system may find it inconvenient to use an X-ray imaging apparatus of a different manufacturer since its screen is different from the one the user is accustomed to.

Thus, a method capable of changing the arrangement of fields that configure the screen so that the arrangement of the fields matches the input order has been considered. The fields (arranged components) that configure the screen are, for example, input items, selection items, and buttons. A method for manually setting the input order is discussed in Japanese Patent Application Laid-Open No. 08-287359. A method for automatically making a setting so that the order of input proceeds from left to right or from top to bottom is discussed in Japanese Patent Application Laid-Open No. 2000-056908 and U.S. Pat. No. 7,263,663.

However, in manually setting the input order as discussed in the above-described Japanese Patent Application Laid-Open No. 08-287359, if many fields (arranged components) configure the screen, although extensive setting becomes possible, the setting takes time. Further, possibility of making an error in the setting is increased. Furthermore, according to the above-described Japanese Patent Application Laid-Open No. 2000-056908 and U.S. Pat. No. 7,263,663, field types are not considered in making the setting so that the fields are set from left to right or from top to bottom. Thus, at the time the information is input, a field that is considered to be low in priority (e.g., determination button) may be selected before a field of higher priority is selected depending on the arrangement of the fields.

### SUMMARY OF THE INVENTION

The present invention is directed to an information processing apparatus with enhanced usability that allows determination of an order of arranged components (fields) while referring to an attribute of each of the arranged components (fields).

According to an aspect of the present invention, an information processing apparatus includes an evaluation unit configured to obtain priority for each arranged component (field) according to attribute information given to the arranged component (field) and a determination unit configured to obtain an order used for selecting the arranged component (field) according to the priority.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram of an X-ray imaging system according to an exemplary embodiment of the present invention.

FIG. 2 is a block diagram of an X-ray imaging apparatus according to an exemplary embodiment of the present invention.

FIG. 3 illustrates an example of a screen display of another X-ray imaging apparatus according to an exemplary embodiment of the present invention.

FIG. 4 illustrates an example of a predetermined screen display of the X-ray imaging apparatus according to an exemplary embodiment of the present invention.

FIG. 5 illustrates an example of a screen display of the X-ray imaging apparatus according to an exemplary embodiment of the present invention after it is customized.

FIG. 6 illustrates an example of a table including fields of the screen of the X-ray imaging apparatus according to an exemplary embodiment of the present invention.

FIG. 7 illustrates an example of a table including fields of the customized screen of the X-ray imaging apparatus according to an exemplary embodiment of the present invention.

FIG. 8 illustrates an example of a table in process of sorting fields of the screen according to an exemplary embodiment of the present invention.

FIG. 9 illustrates an example of a table where the fields of the customized screen are arranged in order.

FIG. 10 is a flowchart illustrating determination of order of shifting between fields according to an exemplary embodiment of the present invention.

FIG. 11 is a table illustrating an example of coordinates of the fields according to an exemplary embodiment of the present invention.

FIG. 12 is a flowchart illustrating control of the X-ray imaging apparatus according to an exemplary embodiment of the present invention.

FIG. 13 illustrates an example of a configuration of a sub-window.

FIG. 14 illustrates an example of a coordinates table of the sub-window and a coordinates table of the fields according to an exemplary embodiment of the present invention.

FIG. 15 illustrates an example of a coordinates table of the sub-window according to an exemplary embodiment of the present invention.

FIG. 16 illustrates an example of the coordinates table of the sub-window according to an exemplary embodiment of the present invention.

FIG. 17 illustrates a customized screen according to an exemplary embodiment of present invention.

FIG. 18 is a flowchart for controlling tab stop according to an exemplary embodiment of the present invention.

FIG. 19 is a flowchart for changing screen setting customized for each user according to an exemplary embodiment of the present invention.

FIG. 20 illustrates a log-in screen according to an exemplary embodiment of the present invention.

FIG. 21 is a flowchart for changing layout of an imaging screen for each client department according to an exemplary embodiment of the present invention.

FIGS. 22A and 22B illustrate configuration examples of a screen prepared for each client department according to an exemplary embodiment of the present invention.

FIG. 23 illustrates an example of a divided sub-window according to an exemplary embodiment of the present invention.

FIG. 24 is a flowchart for sorting by weighted distance according to an exemplary embodiment of the present invention.

FIG. 25 illustrates an example of memory content in a hard disk drive according to an exemplary embodiment of the present invention.

FIG. 26 is a flowchart for controlling fields according to weighted dimension of each area according to an exemplary embodiment of the present invention.

### DETAILED DESCRIPTION OF THE EMBODIMENTS

Various exemplary embodiments, features, and aspects of the invention will be described in detail below with reference to the drawings.

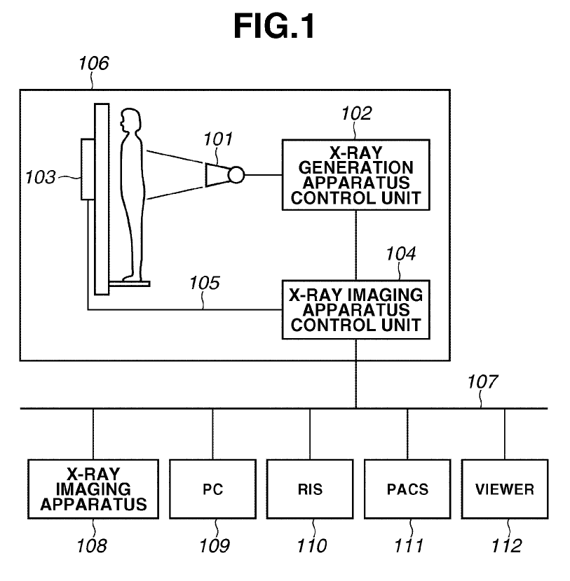

FIG. 1 is a block diagram of an X-ray imaging system including an X-ray imaging apparatus 106 as an example of an information processing apparatus according to an exemplary embodiment of the present invention. In the X-ray imaging apparatus 106, an X-ray generation apparatus control unit 102 controls an X-ray tube 101 to generate an X-ray. An X-ray imaging unit 103 including an X-ray sensor is connected to an X-ray imaging apparatus control unit 104 via a control line 105. The X-ray imaging apparatus control unit 104 is used for sending a control parameter, controlling imaging timing, and transferring images.

The X-ray imaging apparatus control unit 104 is connected to an external personal computer (PC) 109 and a radiology information system (RIS) 110 via a local area network (LAN) 107. The X-ray imaging apparatus control unit 104 is also connected to a picture archiving and communication system (PACS) 111 via the LAN 107. The RIS is a system used by a department of radiology for managing imaging procedure according to a doctor's instruction. The PACS is a system mainly used in medical care and used for sending/receiving image data for medical care on a network.

According to the present exemplary embodiment, imaging is performed by the X-ray imaging apparatus 106 according to an imaging protocol input by a user. The imaging protocol means a unit of X-ray imaging. Imaging conditions such as an imaging portion (e.g., chest, upper arm, lower leg, head, cervical spine, or lumbar), imaging direction, posture, angle, X-ray imaging condition (e.g., X-ray tube voltage, X-ray tube current, irradiation time, or X-ray tube distance) are defined in the imaging protocol. Since a captured image and accompanying information are output to the PACS 111, a user (e.g., a doctor) can carry out diagnosis by obtaining the image by using an image viewer 112. The user can select and use an optimum X-ray imaging apparatus out of X-ray imaging apparatuses including the X-ray imaging apparatus 106 of the present exemplary embodiment and an X-ray imaging apparatus 108 having a screen with a different screen layout.

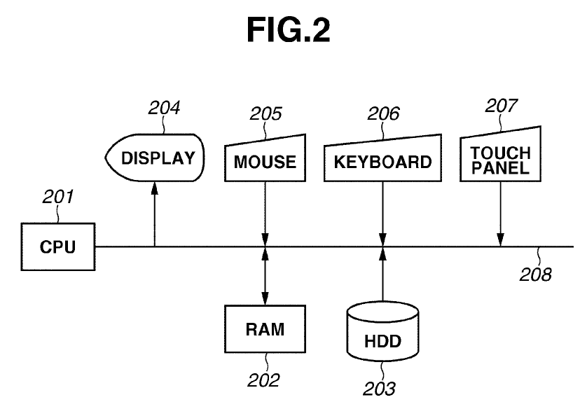

FIG. 2 is a block diagram illustrating details of the X-ray imaging apparatus control unit 104 according to the exemplary embodiment of the present invention. A central processing unit (CPU) 201 is configured to execute a control program for the X-ray imaging apparatus of the exemplary embodiment of the present invention. By executing instructions in a program stored in a memory such as a random access memory (RAM) 202, the CPU 201 controls the apparatus and processes data. Additionally, the CPU 201 instructs the user to input necessary information concerning an arranged component displayed on a display 204. The result of the input is reflected to the display 204.

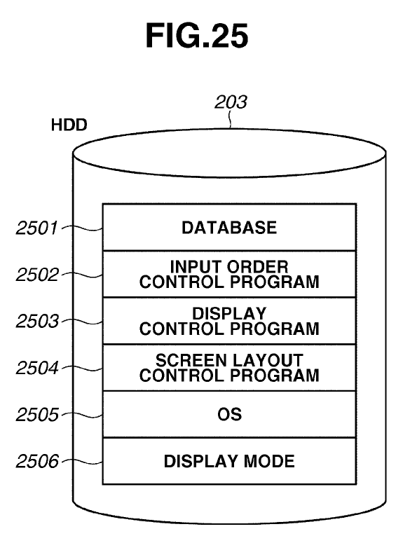

According to the present exemplary embodiment, control programs including a screen layout customization control program, an input order control program, and a display control program are stored in a hard disk drive (HDD) 203. As illustrated in FIG. 25, an operating system (OS) 2505 necessary for starting the X-ray imaging apparatus and a database 2501 necessary for executing programs are stored in the HDD 203. An input order control program 2502, a display control program 2503, and a screen layout control program 2504 run on the OS 2505.

The display 204 displays icons, characters, fields (e.g., input items), and windows (e.g., sub-windows). A mouse 205, a keyboard 206, and a touch panel 207 are input devices. The user operates the X-ray imaging apparatus by using the input devices and the arranged components displayed on the display 204.

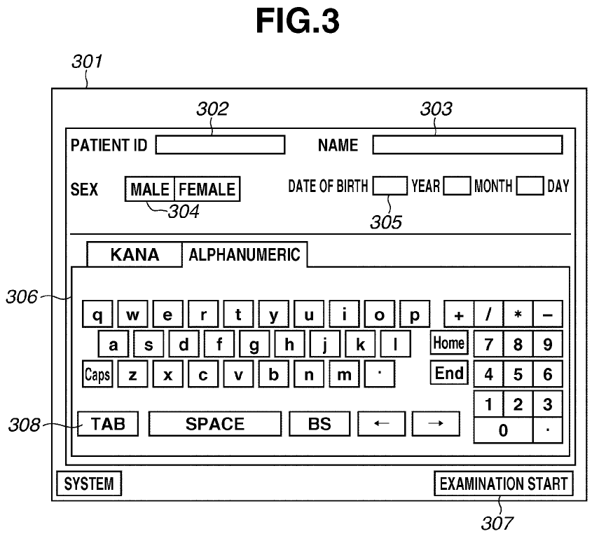

A tab key (or a TAB key 308 in FIG. 3) on the keyboard 206 is used for advancing a cursor to a certain tab stop in a word processor. However, in an application of a personal computer, various functions are assigned to the tab key. The tab key is particularly used for advancing the cursor to the next input item. For example, the input cursor moves to the next item to be input if the tab key is pressed. If the tab key is pressed while the shift key is held down, the input cursor moves to the previously-input item. According to this control called tab stop, the user can sequentially input items without using the mouse 205 and without lifting a hand from the keyboard 206. For this reason, the tab stop is often used in user interfaces including many input items. The key used for advancing the cursor to the next item is not limited to the tab key and, for example, a different key can be used if the function is assigned to the key by the user.

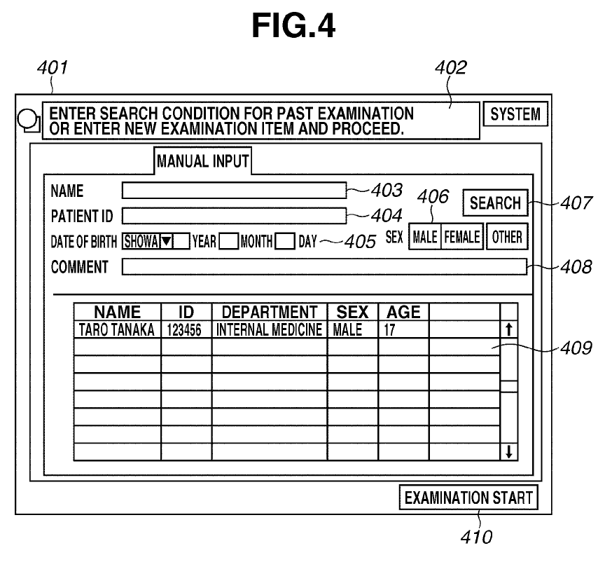

A screen configuration of the X-ray imaging apparatus 106 according to the exemplary embodiment of the present invention, for example, at the time of shipment, is illustrated in a configuration 401 in FIG. 4. According to the display control program 2503, which is executedby the CPU 201, a message that indicates operations to be performed by the user is displayed in a message field 402 on the display 204.

The user fills a patient name field 403, a patient ID field 404, a date of birth field 405, a sex field 406, and a comment field 408 concerning patient attribute using, for example, the mouse 205, the keyboard 206, or the touch panel 207. Subsequently, by pressing an examination start instruction button 410, the input information is transmitted to a program executed by the CPU 201 and a new examination is started.

If the patient is a hospital inpatient and has an X-ray image taken before, the user inputs a part of the patient's name in the patient name field 403 and presses a search button 407. Then, according to a program executed by the CPU 201, a table 409 is displayed on the screen. The table 409 includes past examination data that matches the part of the patient's name that has been input. Subsequently, the user selects a patient from the table using a pointing device such as the mouse 205 or the keyboard 206 and presses the examination start instruction button 410. With this operation, the examination is started.

Next, input order control of the X-ray imaging apparatus will be described referring to FIGS. 3 through 5. For example, the X-ray imaging apparatus 106 according to the exemplary embodiment of the present invention having the user interface illustrated in FIG. 4 and the X-ray imaging apparatus 108 having the user interface illustrated in FIG. 3 are installed in a hospital.

If the user (e.g., a radiological technologist) is accustomed to operating the X-ray imaging apparatus 108, the screen layout of the X-ray imaging apparatus 106 according to the exemplary embodiment of the present invention is preferably changed to a screen layout similar to the screen layout of the X-ray imaging apparatus 108.

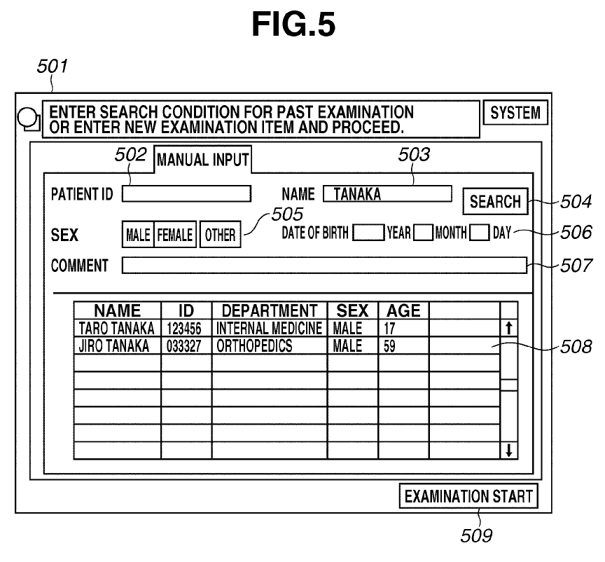

By executing the screen layout control program 2504, by the CPU 201, stored in the HDD 203, the screen layout of the X-ray imaging apparatus 106 according to the exemplary embodiment of the present invention can be customized. For example, a layout of the screen can be changed to a layout similar to a screen 301 of the X-ray imaging apparatus 108. An example of such a layout is illustrated in FIG. 5 (screen 501). The customization can be performed by using the mouse 205, the keyboard 206, or the touch panel 207 and by using a table. The table includes positions and sizes of the arranged components. Further, the arranged components (fields) of the layout can be visually moved by a drag-and-drop operation.

Although the coordinates and the size of the fields can be arbitrarily arranged, the fields are arranged according to a discrete interval layout called a layout grid. For example, if the layout grid is 5, then when the user moves the field on a layout tool, the position of the field is moved in units of 5. Similarly, when the user changes the size of the field, the size of the field is changed by units of 5. In this way, a slight overlap of the coordinates of a screen field with those of a different screen field as well as misalignment of the screen fields can be prevented. Thus, the fields can be aligned as planned by the user.

On the screen 501 in FIG. 5, the user enters patient information as an example of subject information. The patient information is, for example, input in a patient ID field 502, patient name field 503, sex field 505, and date of birth field 506. Further, the user can add a comment on the patient attribute in a comment field 507. Then, the examination is started by operating an examination start button 509.

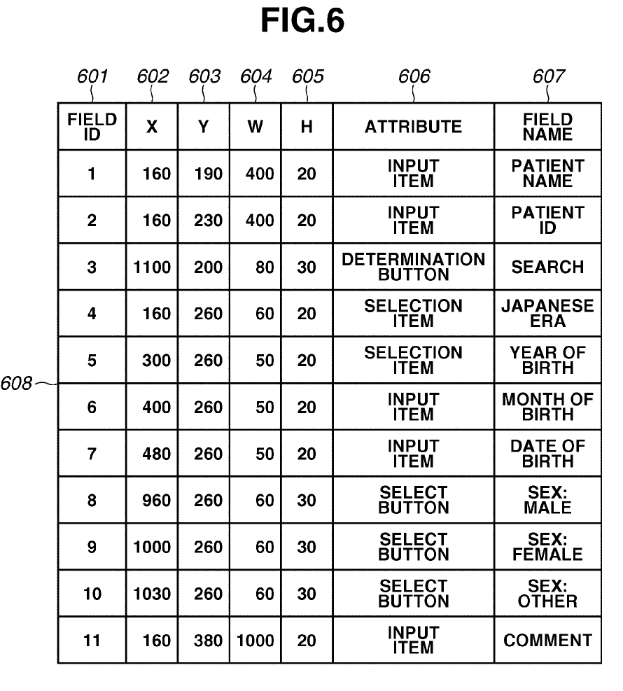

Display coordinates and attribute values of screen configuration fields employing the tab stop function out of all the screen configuration fields are stored in the HDD 203 in the database 2501 in a form of a table 608 illustrated in FIG. 6. When the CPU 201 executes the input order control program 2502 of the present exemplary embodiment, the database 2501 is used. Further, according to the input order control program 2502, a field ID is assigned to each field that employs the tab stop function. For example, a patient name entered in the patient name field 403, a patient ID entered in the patient field ID 404, the search button 407, a date of birth entered in the date of birth field 405, a sex entered in the sex field 406, and a comment entered in the comment field 408 concerning patient attribute are assigned to the field IDs 1, 2, 3, 4 to 7, 8 to 10, and 11, all of which are in cells of a field ID column 601 in FIG. 6, respectively.

An upper left X-coordinate, an upper left Y-coordinate, a width in pixels, and a height in pixels of a field for the field ID column 601 are presented in cells in columns 602 through 605, respectively. The screen is formed based on such position information. The position information is not limited to the information described above and information such as center of gravity or coordinates of a different vertex can also be used. According to established practice, the upper left point of the display 204 is determined as a point of origin. Further, the row direction and the columns direction are determined as the X-direction and the Y-direction, respectively.

Information in cells in a column 606 indicates attribute information of the fields as an example of attribute information. The information in these cells is used for controlling an order of movement of the above-described fields. In the table 608, an input item, a selection item, a select button, and a determination button are set as examples of attribute information of the fields. The input item indicates that characters are input in the field. The selection item indicates that the selection can be made using a pull-down menu. The select button indicates that the user can choose on or off. The determination button indicates that information input by the input device can be determined by the user.

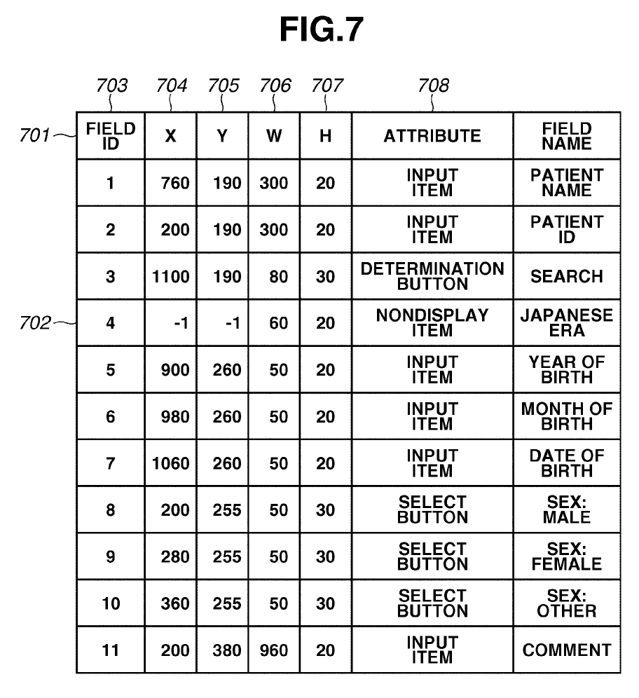

Cells in a column 607 include field names. Each field name is stored in the HDD 203. The field names are not related to the control. Generally, the order of movement of the cursor by the operation of the tab key also is defined at the time of program designing. In order to change the movement order, it is necessary to redefine the field definition. According to the screen layout control program 2504, coordinates of fields when the screen layout is changed to the screen illustrated in FIG. 5 are stored in the HDD 203 in a form of a table 701 illustrated in FIG. 7 by a program executed by the CPU 201.

In order not to display a Japanese era name, which is included in the date of birth field 405, in the date of birth field 506 on the screen 501, the cells in column 704 representing the upper left X-coordinate and column 705 representing the upper left Y-coordinate in the row of field ID 4 will be set to be “−1”. Further, the item of the cell in a column 708 presenting attribute information in the row of field ID 4 will be set as a nondisplay item and stored in the HDD 203 as such. When this layout change is performed, if the cursor moves from top to bottom in the order of the field IDs in a column 703 according to an operation of the tab key, the arrangement of the fields on the screen does not match the input order.

For example, if the order of input is the same as the order shown in table 701 in FIG. 7, then the input cursor moves on the screen illustrated in FIG. 5 in the order of the patient name field 503, the patient ID field 502, search button field 504, the date of birth field 506, the sex field 505, and the comment field 507.

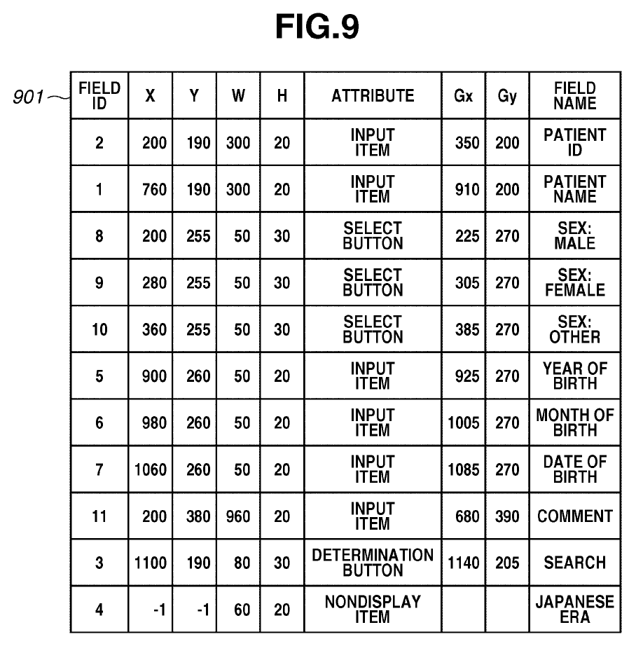

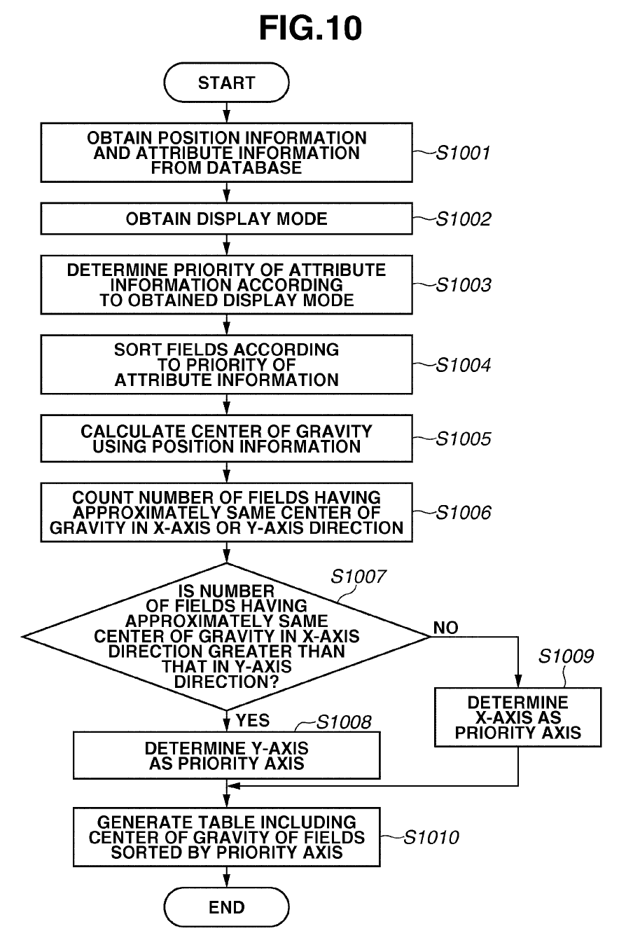

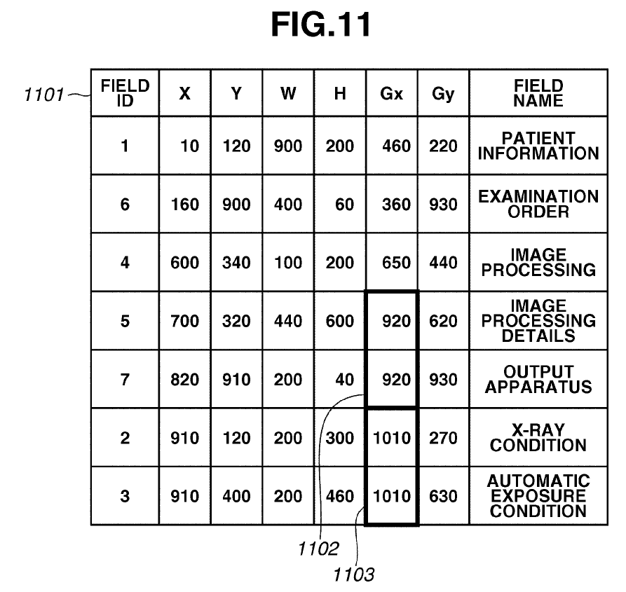

Thus, by using the columns 704 and 705, a column 706 presenting a number of pixels of the width W of the field, a column 707 presenting a number of pixels of the height H of the field 707, and the column 708 presenting attribute information, the field management table is rearranged as illustrated in table 901 in FIG. 9. Details of the processes will be described using a flowchart illustrated in FIG. 10. The control of the processes is executed by the CPU 201.

First, in step S1001, the CPU 201 obtains position information and attribute information from the database 2501 stored in the HDD 203.

Next, in step S1002, the CPU 201 obtains a display mode stored in the HDD 203. The display mode indicates the display content information. For example, the CPU 201 obtains information whether the screen is for inputting the patient information, preparation of X-ray imaging, or confirmation of the imaging screen.

In step S1003, the CPU 201 determines priority of the attribute information that depends on the obtained display mode. The determination of the priority is described referring to the screen 501 illustrated in FIG. 5. The screen 501 is a screen used for entering patient information.

In this case, emphasis is put on entering information. Although the priority of each of the input item, the selection item, and the selection button is equal, the priority of the determination button is set to a lower priority. Further, the priority of the nondisplay item is set to the lowest priority. The order of fields is rearranged so that the fields with a higher priority are placed above those with a lower priority in the field management table.

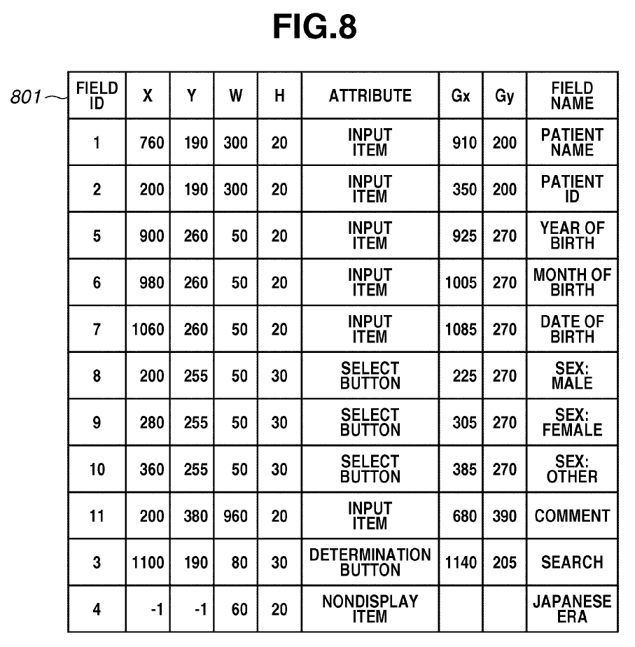

In step S1004, according to the above-described priority, the table 701 in FIG. 7 is rearranged to a table 801 in FIG. 8. The table 801 can be stored temporarily in the RAM 202 or in the HDD 203.

Next, in step S1005, the CPU 201 calculates an X-coordinate 802 which is an X-coordinate of a center of gravity of a field according to the coordinate illustrated in FIG. 8 by using an equation Gx=X+W/2. The CPU 201 also calculates a Y-coordinate 803 which is a center of gravity of a field according to the coordinate illustrated in FIG. 8 by using an equation Gy=Y+H/2. The results of the calculation are stored in the RAM 202.

In step S1006, the CPU 201 counts the number of fields whose center of gravity is approximately collinear on the X-axis or the Y-axis. According to the table 801, six fields are collinear at Y=270 and two fields are collinear at Y=200. There are no fields that are approximately collinear on the X-axis.

Here, the fields that are approximately collinear include a field whose coordinate slightly overlaps with a coordinate of another field and a field that is slightly misaligned with another field. For example, if a quotient of a coordinate of a field divided by 5 equals a quotient of a coordinate of a different field, the fields can be regarded as a same field.

In step S1007, the CPU 201 determines whether the number of fields whose center of gravity is approximately collinear on the X-axis is greater than the number of fields whose center of gravity is approximately collinear on the Y-axis. If the number of fields whose center of gravity is approximately collinear on the X-axis is larger (YES in step S1007), then the processing proceeds to step 1008. In step S1008, the CPU 201 determines the Y-axis as the priority axis. If the Y-axis is set as the priority axis, the cursor is moved in the direction of Y-axis.

On the other hand, in step S1007, if the number of fields whose center of gravity is approximately collinear on the Y-axis is greater than or equal to the number of fields whose center of gravity is approximately collinear on the X-axis (NO in step S1007), then the processing proceeds to step S1009. In step S1009, the CPU 201 determines the X-axis as the priority axis. If the X-axis is set as the priority axis, the cursor is moved from left to right or in the direction of the X-axis while keeping the Y-coordinate.

If a pair of fields whose center of gravity is approximately the same as shown in the fields 1102 in the table 1101 exists, and further, another pair of fields whose center of gravity is approximately the same as shown in the fields 1103 exists, the number of fields whose center of gravity is approximately the same is counted as four. In this way, smooth layout operation can be performed.

Further, although the CPU 201 determines that it is preferable to move the cursor in the Y-axis direction if the number of fields whose center of gravity is approximately collinear on the X-axis is greater than the number of fields whose center of gravity is approximately collinear on the Y-axis in the above description, the CPU 201 can determine that it is preferable to move the cursor in the X-axis direction. According to the flowchart in FIG. 10, the priority axis is determined to be the X-axis in step S1009.

In step S1010, using the Y-coordinate 803 of the center of gravity, the fields are primary-sorted in ascending order with respect to the values of the Y-coordinates as the Y-axis is determined not to be the priority axis. Further, based on the result of the primary sort, a secondary sort will be performed. In the secondary sort, using the X-coordinate 802 of the center of gravity, the fields are sorted with respect to the values of the X-coordinates since the X-axis is determined to be the priority axis. As a result, a priority input order of the fields illustrated in FIG. 9 is determined.

The calculation and sorting of the coordinates of the center of gravity is performed based on a control program executed by the CPU 201. Even if the attribute information of the coordinates is not set as “nondisplay”, if the value of the X-coordinate or the Y-coordinate is negative, the field is not displayed on the screen. Thus, the coordinates of the center of gravity are not calculated.

According to the order of the field ID in FIG. 9, the user can input and determine the fields in the order of the patient ID field 502, the patient name field 503, the sex field 505, the date of birth field 506, the comment field 507, and search button 504 on the screen. In this way, in an order determined by the control program, movement control of the input cursor can be added to the program. Although the fields are sorted in ascending order according to the present exemplary embodiment, the fields can also be sorted in descending order.

Further, although the results of the sorting by the X-axis and the Y-axis is used according to the present exemplary embodiment, a reference point defined by the display mode can also be used in determining the order. Additionally, the order can be determined by using a reference point that is defined depending on a state of the X-ray imaging apparatus by a different method.

For example, in a case of a screen for entering patient information, the fields can be sorted in the order of descending proximity or ascending proximity from the point of origin by setting the reference point as a point of origin. In a case of a screen for preparation of X-ray imaging, the reference point is changed to a point having coordinates (600, 300), and the fields can be sorted according to distance. The distance can be a direct distance or a grid point interval distance.

Further, the order of the fields can be determined by sorting the fields using an absolute value of coordinates obtained by subtracting coordinates of the reference point from coordinates of a center of gravity of each field, and sorted by the X-axis or the Y-axis as described above. If the result of the subtraction of the X-coordinate or the Y-coordinate is negative, the priority can be lowered or the field having the negative coordinate can be removed from the fields employing the tab stop.

Further, if the display 204 is capable of three-dimensional display, the fields can be sorted by a Z-axis that is perpendicular to the plane formed by the X- and the Y-axes.

The input screen of the examination information illustrated in the first exemplary embodiment includes a single function for entering patient information. Thus, one sub-window, as a unit of a function block, is provided on the screen. According to the present exemplary embodiment, a movement order of the input cursor is determined when a plurality of functions are displayed on a screen.

According to the present exemplary embodiment, since block diagrams of the X-ray imaging system and the X-ray imaging apparatus control unit 104 are similar to those illustrated in FIGS. 1 and 2 according to the first exemplary embodiment, components similar to those in FIGS. 1 and 2 are denoted by the same reference numerals and their description is omitted for simplification.

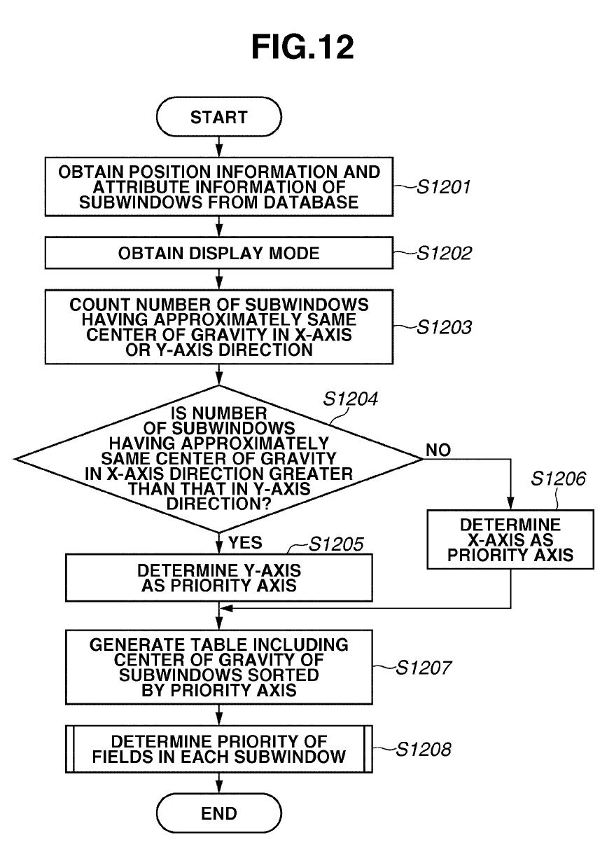

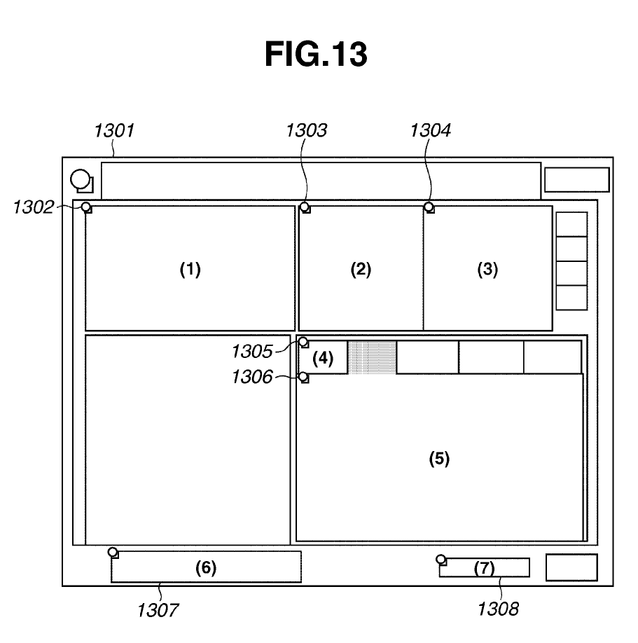

Now referring to a flowchart in FIG. 12, an example of the input order control program 2502 executed by the CPU 201 determining a priority input order of a plurality of sub-windows that configure an imaging screen 1301 in FIG. 13 will be described.

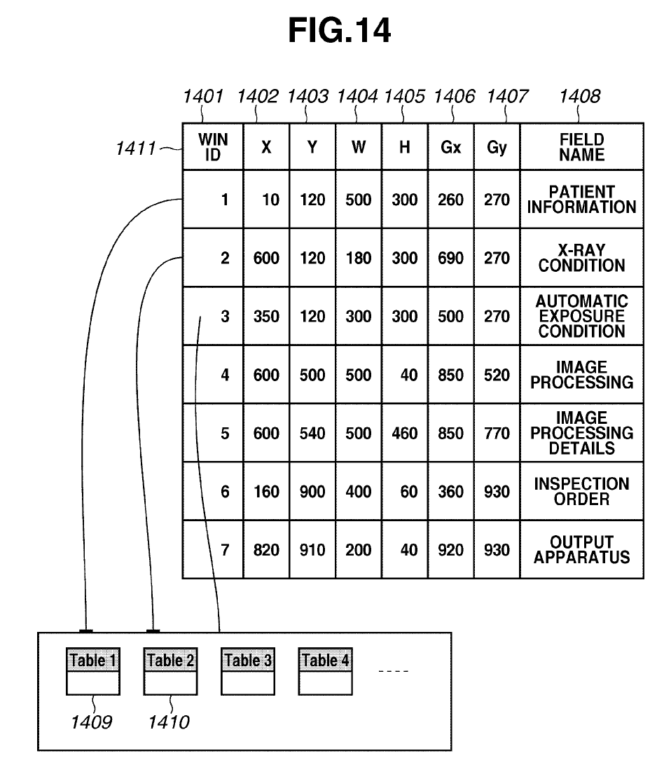

First, in step S1201, a coordinates table including position information of the sub-windows is read out from the database 2501. The coordinates table is, for example, stored in the HDD 203 in a form of a table 1411 in FIG. 14. Each row in the table indicates a sub-window including the fields that are tab stopped.

Patient information is displayed in a sub-window 1302, an imaging condition of the X-ray generation apparatus is displayed in a sub-window 1303, and an imaging condition of an automatic exposure control device is displayed in a sub-window 1304.

A sub-window 1305 is used for selecting a group of fields for adjusting a parameter of the image processing. A lower level sub-window selected according to the parameter is displayed on a sub-window 1306. The order of imaging is selected using a sub-window 1307. An output apparatus of the image can be changed using a sub-window 1308.

Each row in the table 1411 represents a position and a size of each sub-window in FIG. 13. The size of each sub-window can be changed. Further, each sub-window can be set so as not to be displayed. The fields in the sub-window are stored in a different table. For example, coordinates of each field in the sub-window 1302 are stored in a table 1409. Similarly, each field in the sub-window 1303 is stored in a table 1410.

Each cell in a column 1401 includes a sub-window ID. Each cell in a column 1402 includes an upper left X-coordinate of the sub-window. Each cell in a column 1403 includes an upper left Y-coordinate of the sub-window. A width of the sub-window or a number of pixels in the X-axial direction and a height of the sub-window or a number of pixels in the Y-axial direction are recorded in the cells in columns 1404 and 1405, respectively. Each cell in a column 1406 includes an X-coordinate of a center of gravity of a sub-window calculated by a program. Similarly, each cell in a column 1407 includes a Y-coordinate of a center of gravity of a sub-window.

In step S1202, the CPU 201 obtains a display mode.

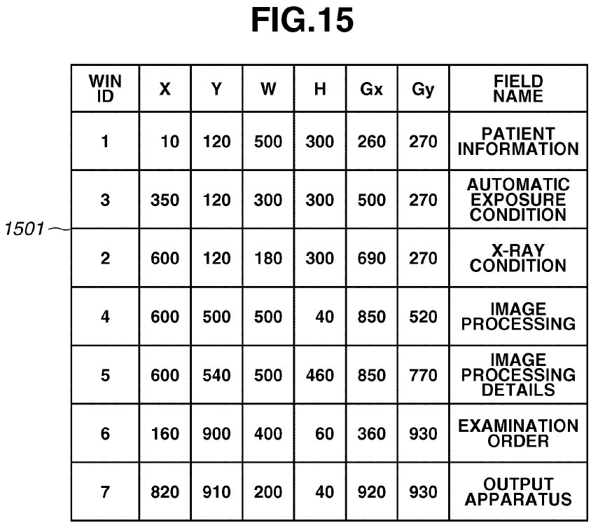

In step S1203, the CPU 201 counts a number of sub-windows having approximately the same center of gravity in the Y-axis direction. FIG. 15 illustrates a result of the sub-windows in the table 1411 primary-sorted by the column 1407 representing the Y-coordinate of the center of gravity of the sub-windows, and then secondary-sorted by the column 1406 representing the X-coordinate of the center of gravity of the sub-windows. According to the example illustrated in FIG. 15, three sub-windows align at y=270 and two sub-windows align at y=930.

Similarly, the CPU 201 counts a number of sub-windows having approximately the same center of gravity in the X-axis direction. FIG. 15 illustrates a result obtained when the sub-windows are secondary-sorted by the column 1406 representing the X-coordinate of the center of gravity of the sub-windows.

Next, in step S1204, if the number of sub-windows having approximately the same center of gravity in the X-axis direction is greater than the number of sub-windows having approximately the same center of gravity in the Y-axis direction (YES in step S1204), then the CPU 201 determines that it is preferable to move the cursor in the Y-axial direction, and the processing proceeds to step S1205. In step S1205, the CPU 201 determines the Y-axis as the priority axis. Since the number of sub-windows having the center of gravity in the X-axis direction at x=850 is two, the CPU 201 determines that it is efficient to move the cursor downward on the screen without moving the cursor in the X-axial direction.

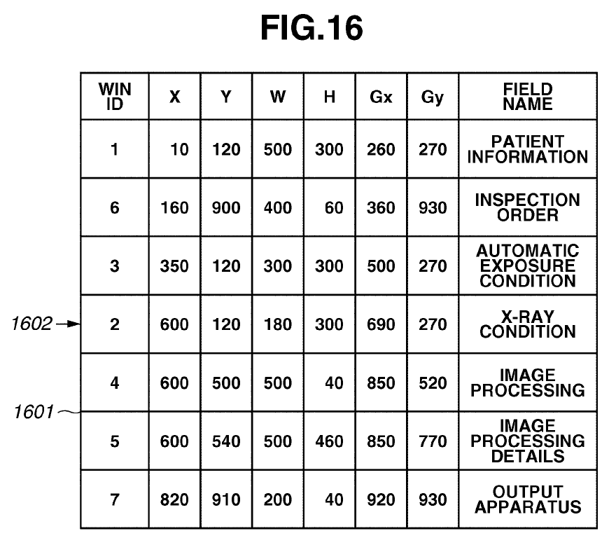

In step S1204, if the number of sub-windows having approximately the same center of gravity in the Y-axis direction is greater than or equal to the number of sub-windows having approximately the same center of gravity in the X-axis direction (NO in step S1204), then the processing proceeds to step S1206. In step S1206, the CPU 201 determines the X-axis as the priority axis. In other words, the X-coordinate direction is given priority in the cursor movement and the table 1501 in FIG. 15 instead of table 16 in FIG. 16 is employed as the table used in determining order. In step S1207, the CPU 201 generates a table having the sub-windows secondary-sorted by the priority of the determined input items and stores it in the HDD 203.

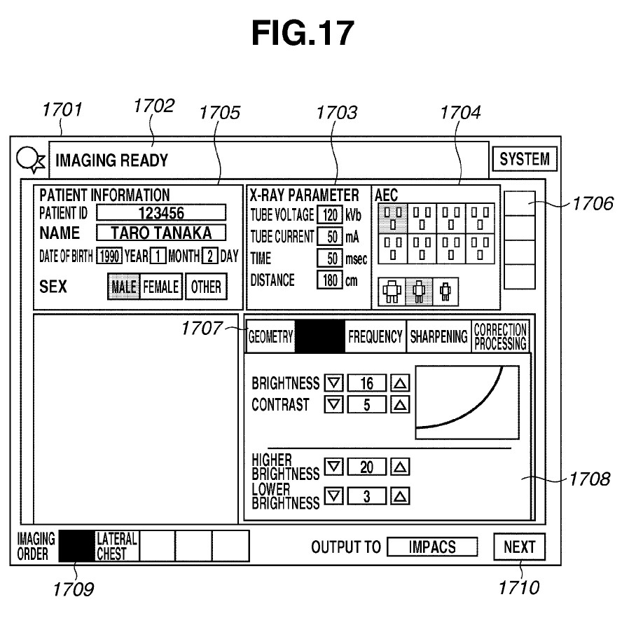

Next, in step S1208, the CPU 201 changes the selection order of the fields in each sub-window as described above and determines the priority of tab stop in the sub-window. As a result, sub-windows and fields in the sub-windows are displayed as illustrated in FIG. 17, and further, the input order is automatically determined.

According to the present exemplary embodiment, the priority is determined according to only the position information of the sub-windows. However, if attribute information is provided to the sub-windows, in a manner similar to the determination method used for determining the priority of the fields, display mode and the attribute information can be used for determining the priority of the sub-windows.

For example, the sub-windows are provided with various attribute information of the window and classified, for example, into a patient information window, an imaging portion information window, an imaging condition information window, and an image processing parameter information window. Using the attribute information, the priority of the sub-windows can be determined. For example, in the imaging preparation state, the patient information window is given the highest priority, whereas the image processing parameter information window is given the highest priority when the state of the imaging screen is confirmed.

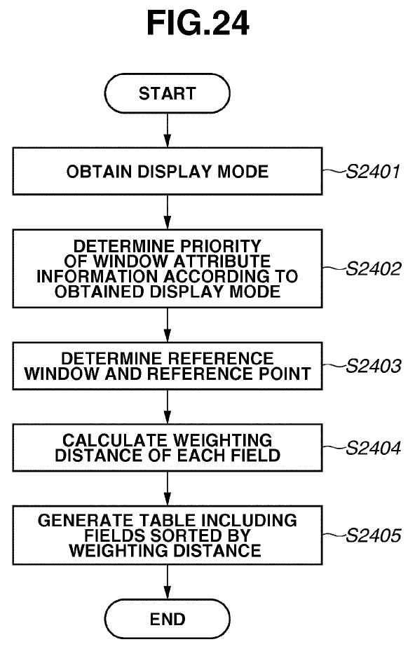

According to a third exemplary embodiment, a plurality of sub-windows are arranged on one screen. This is controlled by the input order control program 2502 for determining order of input cursor, and which is different from the one described according to the second exemplary embodiment. The processes are described referring to the flowchart in FIG. 24.

According to the present exemplary embodiment, since block diagrams of the X-ray imaging system and the X-ray imaging apparatus control unit 104 are similar to those illustrated in FIGS. 1 and 2 according to the first exemplary embodiment, components similar to those in FIGS. 1 and 2 are denoted by the same reference numerals and their description is omitted for simplification. The input order control program 2502 is executed by the CPU 201.

In step S2401, the CPU 201 obtains a display mode. In step S2402 the CPU 201 determines the priority of the window attribute information according to the obtained display mode. Here, the priority of the windows is in the order of the imaging portion information window, the imaging condition information window, the patient information window, and the image processing parameter information window, and the priority parameters of the windows in the order of 7, 5, 3, and 1, respectively.

In step S2403, the CPU 201 determines the sub-window having the highest priority as the reference window and also sets the upper left coordinates as the reference point of the reference window. If a plurality of sub-windows having window attribute information exist, a sub-window that is closest to the point of origin is determined as the reference window.

In step S2404, the CPU 201 calculates a weighted distance from the reference point to each field. The weighting means, for example, multiplying an absolute value of a difference between priority parameters if the fields are in a sub-window having window attribute information different from the attribute information of the reference window.

For example, a weighing distance of field coordinates (600, 400) of a field in an image processing parameter information window having a priority parameter of 1 to an imaging portion information window with a reference point (200, 100) and having a priority parameter 7 is calculated according to the expression 1 below.

|1-7\sqrt{(600−200)²+(400−100)²} (1)

By sorting the fields based on the calculated weighted distance, the selection order of the fields can be determined.

Further, the method for weighting is not limited to the above-described method and various methods can be used.

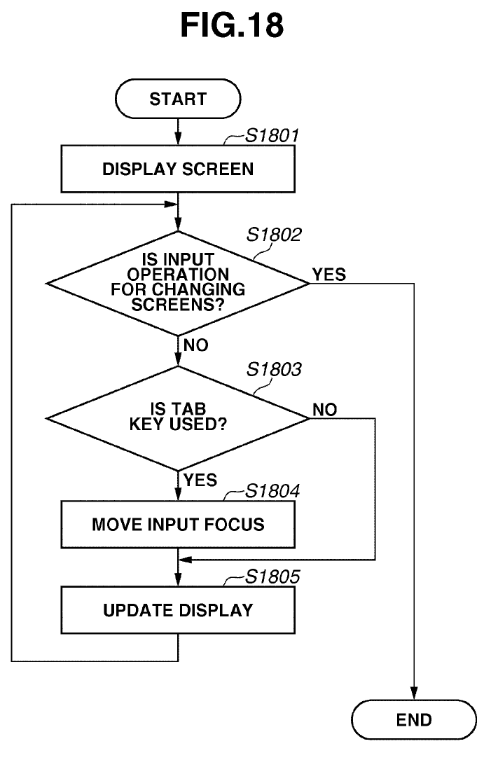

In a fourth exemplary embodiment, an example of the input order control program 2502 that controls the tab stop according to the order determined as described above will be described using the flowchart in FIG. 18.

According to the present exemplary embodiment, since block diagrams of the X-ray imaging system and the X-ray imaging apparatus control unit 104 are similar to those illustrated in FIGS. 1 and 2 according to the first exemplary embodiment, components similar to those in FIGS. 1 and 2 are denoted by the same reference numerals and their description is omitted for simplification. The input order control program 2502 is executed by the CPU 201.

First, in step S1801, the CPU 201 displays the screen. In step S1802, the CPU 201 determines whether the input operation is for changing screens each time an input is made by a key or mouse operation. If the input operation is for changing screens (YES in step S1802), then the processing ends.

In step S1802, if the input operation is not for changing screens (NO in step S1802), then the processing proceeds to step S1803. In step S1803, the CPU 201 determines whether the input key is the tab key. If the CPU 201 determines that the input key is the tab key (YES in step S1803), then the processing proceeds to step S1804. In step S1804, an input focus 1602 (see FIG. 16) is moved to the next row in the table and to the item in the sub-window.

If the tab key is pressed while the shift key is held down, then the input focus 1602 is moved to the row above. If the input focus 1602 is moved to the first row of the table, then the table is changed to a table of a higher level, and the input focus 1602 is moved to the next sub-window.

In step S1803, if the CPU 201 determines that the input key is not the tab key (NO in step S1803), then the processing proceeds to step S1805. In step S1805, the CPU 201 updates the screen display.

According to the present exemplary embodiment, the coordinates of the arranged components in the database 2501 are read out when the application is executed, and the priority is determined for each attribute according to the display mode using the control program. Further, the input order is determined based on the result of the sorting by the coordinates. In addition to reading the screen configuration coordinates when the screen is changed and determining the input order, a method by which calculation is performed each time the tab key is pressed is also interpreted as the present invention.

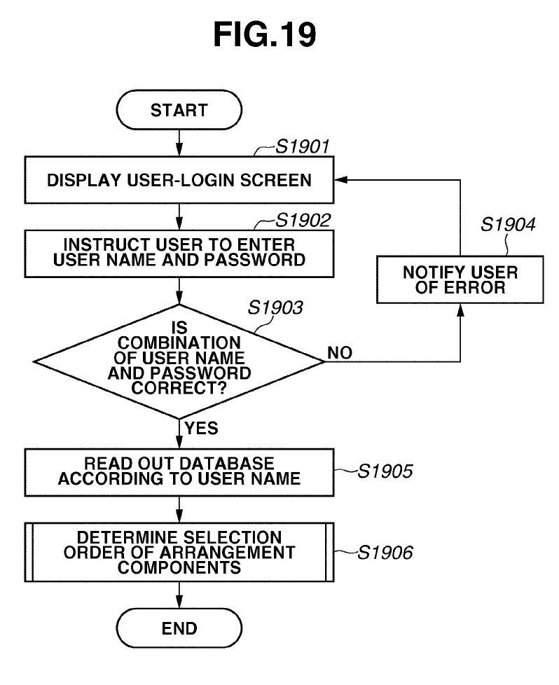

In a fifth exemplary embodiment, an example of customization for each user will be described referring to the flowchart in FIG. 19. The processes in the flowchart are realized by the CPU 201 of the X-ray imaging apparatus control unit 104 executing the input order control program 2502.

According to the present exemplary embodiment, since block diagrams of the X-ray imaging system and the X-ray imaging apparatus control unit 104 are similar to those illustrated in FIGS. 1 and 2 according to the first exemplary embodiment, blocks similar to those in FIGS. 1 and 2 are denoted by the same reference numerals and their description is omitted for simplification.

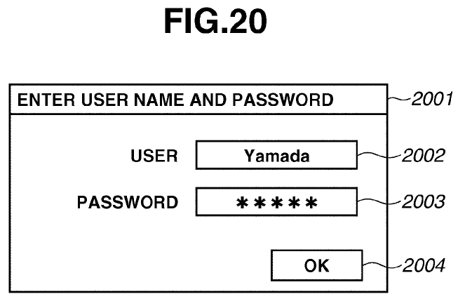

First, in step S1901, the CPU 201 displays an operation screen (a user log-in screen 2001) of the X-ray imaging apparatus control unit 104 illustrated in FIG. 20 on the display 204.

Next, in step S1902, the CPU 201 instructs the user of the X-ray imaging apparatus 106 to enter a user name 2002 and a password 2003 as examples of an input instruction using an input device, and to press an OK button 2004. When the OK button 2004 is pressed, the processing proceeds to step S1903.

In step S1903, the CPU 201 determines whether a combination of the user name and the password is correct.

If the combination is determined to be incorrect (NO in step S1903), then the processing proceeds to step S1904. In step S1904, the CPU 201 notifies the user of the error, and then the processing returns to step S1901. In step S1903, if the combination is determined to be correct (YES in step S1903), then the processing proceeds to step S1905. In step S1905, the CPU 201 reads out the database 2501 from the HDD 203 according to the user name.

In step S1906, the CPU 201 changes the screen layout to the layout described in the first exemplary embodiment according to the database 2501 which is read out. Then, the selection order of the arranged components according to the screen layout will be determined. By changing the layout and the selection order of the arranged components for each user by changing the database 2501, a layout easy to operate can be realized, and thus imaging can be performed quickly.

According to the present exemplary embodiment, the input order of the input fields can be automatically changed to an appropriate order by changing only the coordinates of the fields according to the screen configuration. This eliminates the need for an input specifying unit used for specifying order of fields or a storage unit.

The assignment of the priority order can be changed according to the user if the change is within the range of the above-described exemplary embodiments.

In a sixth exemplary embodiment, a layout of an imaging screen of an X-ray imaging apparatus in a hospital is changed. If a client department of the imaging is internal medicine or surgical surgery, several images are taken. However, if the client department is orthopedics, images of more than ten are frequently taken. Thus, after obtaining an order via the RIS using the examination order input screen, it is desirable that the layout of the imaging screen can be changed according to the client department.

Further, in a case of a health check, the number of images to be taken is usually determined in advance, and thus the order is not obtained via the RIS. Accordingly, the fields that configure the screen are different. In other words, it is desirable that the screen layout can be changed to an optimum layout according to the purpose and use application of the imaging.

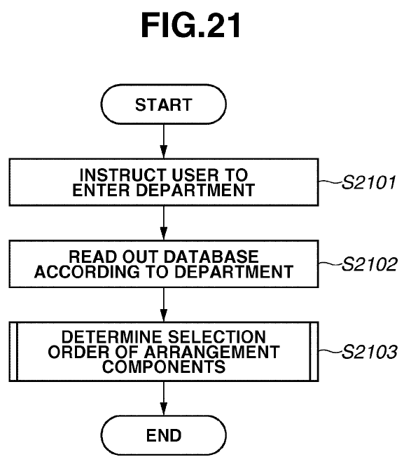

Next, the input order control program 2502 in a case the layout of the imaging screen is changed according to the client department will be described referring to the flowchart illustrated in FIG. 21. The input order control program 2502 is executed by the CPU 201.

According to the present exemplary embodiment, since block diagrams of the X-ray imaging system and the X-ray imaging apparatus control unit 104 are similar to those illustrated in FIGS. 1 and 2 according to the first exemplary embodiment, blocks similar to those in FIGS. 1 and 2 are denoted by the same reference numerals and their description is omitted for simplification.

First, in step S2101, the CPU 201 instructs the user to enter the client department, as an example of the input instruction, using the input device. The client department can be automatically determined according to which PC 109 on the network has sent the imaging request.

Instep S2102, the CPU 201 reads out the database 2501. Next, in step S2103, the CPU 201 changes the screen layout as described in the first exemplary embodiment, and determines the selection order of the arranged components according to the screen layout.

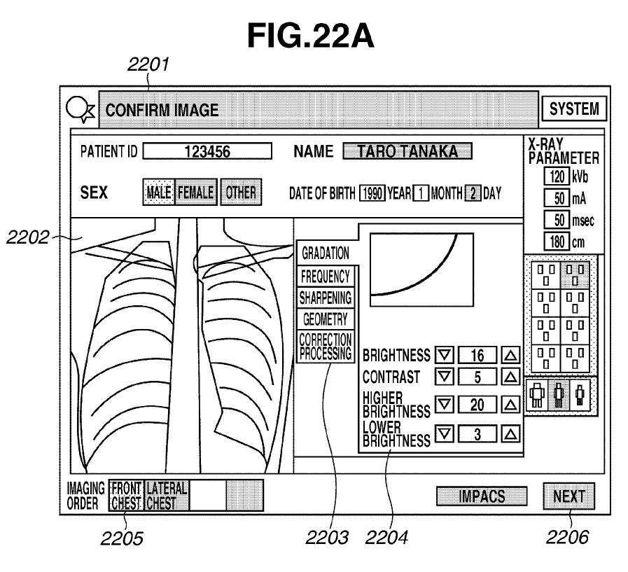

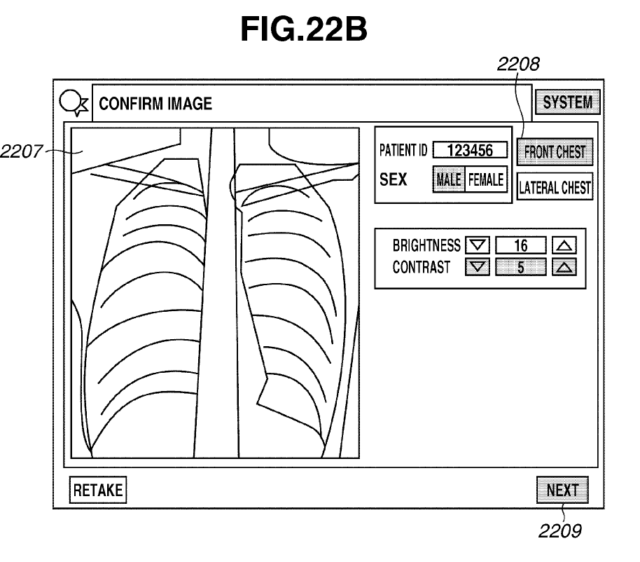

In this way, the screen layout can be changed according to the client department as, for example, illustrated in FIGS. 22A and 22B.

Further, in an apparatus capable of performing still image X-ray imaging as well as fluoroscopic imaging, the screen configuration is changed depending on the type of imaging. According to the present exemplary embodiment, by changing a part of the database 2501 that configures the sub-window, the imaging screen can be partially changed. In this case also, the input order is not necessarily set, and the input order can be controlled according to the screen layout.

According to the present exemplary embodiment, the internal medicine, surgery, and orthopedics are taken as examples of the client department. The present invention, however, is not limited to such departments and a department such as a sales department or a development department can send a similar request for imaging.

According to the first exemplary embodiment, the arranged components are sorted by the attribute information, the number of fields aligned in a substantially straight line is counted, and then the direction of the movement is determined.

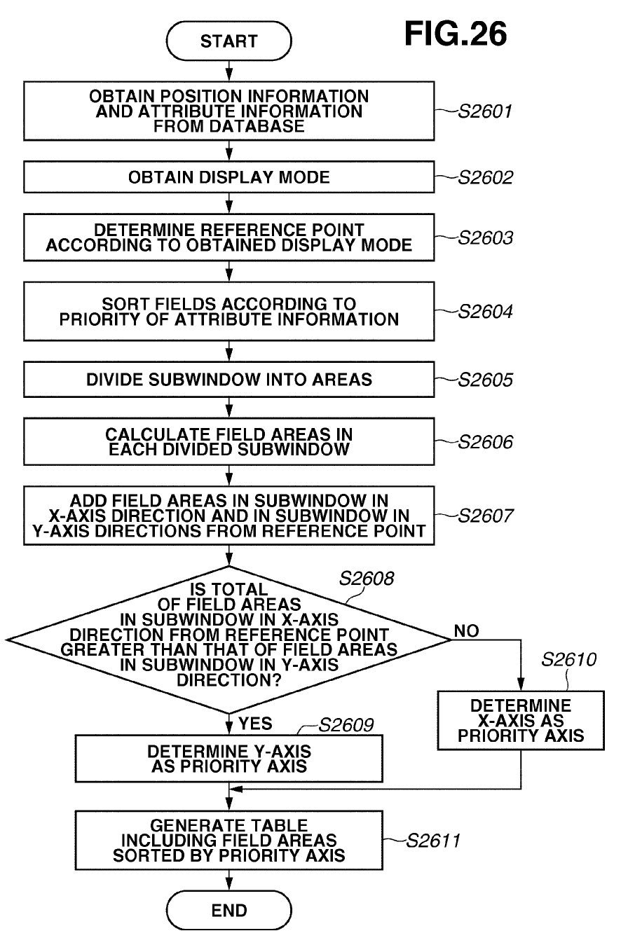

In a seventh exemplary embodiment, input field coordinates are determined according to a different method. This method is described referring to the flowchart in FIG. 26. The CPU 201 executes the input order control program 2502 for determining the input field coordinates. According to the present exemplary embodiment, since block diagrams of the X-ray imaging system and the X-ray imaging apparatus control unit 104 are similar to those illustrated in FIGS. 1 and 2 according to the first exemplary embodiment, blocks similar to those in FIGS. 1 and 2 are denoted by the same reference numerals and their description is omitted for simplification. The input order control program 2502 is executed by the CPU 201.

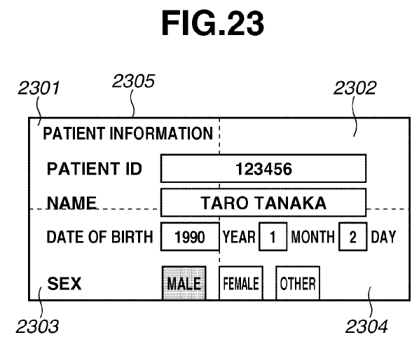

First, in step S2601, the CPU 201 obtains position information and attribute information from the database 2501 stored in the HDD 203. In step S2602, the CPU 201 obtains a display mode 2506 stored in the HDD 203. In step S2603, the CPU 201 determines a reference point according to the obtained display mode. Here, for example, the upper left corner of the window in FIG. 23 is determined as the reference point.

In step S2604, as is with the first exemplary embodiment, the CPU 201 evaluates the priority which is given by the attribute information using the display mode, and the arranged components are sorted based on the obtained result.

In step S2605, the CPU 201 divides the area in the sub-window, for example, into two each in the X-axis and the Y-axis directions as illustrated in FIG. 23. To be more precise, the sub-window 2305 in FIG. 23 is divided into upper left division area 2301, upper right division area 2302, lower left division area 2303, and lower right division area 2304.

In step S2606, the input is started from the upper left division area 2301. The division area to be input after the upper left division area 2301 is either the upper right division area 2302 or the lower left division area 2303. In order to determine the next division area to be input, the area of the fields included in each division area is calculated. If a field is located in two division areas, the area of the fields that exist in each division area may be calculated or the area of the fields that exist in each division area having the center of gravity in that division area may be calculated.

In step S2607, the CPU 201 adds the area of the fields included in the areas located in the X-axial direction with respect to the reference point determined in step S2603, in other words, the area of the fields included in the upper left division area 2301 and the upper right division area 2302. Similarly, the CPU 201 adds the area of the fields included in the areas located in the Y-axial direction with respect to the reference point, in other words, the area of the fields included in the lower left division area 2303 and the lower right division area 2304.

In step S2608, the CPU 201 compares the total field area in the division areas located in the X-axial direction with the total field area in the division areas located in the Y-axial direction. The area having a larger field area is given priority in the input operation. If the total field area located in the X-axial direction is larger than that located in the Y-axial direction (YES in step S2608), then the process proceeds to step S2609. In step S2609, the CPU 201 determines the X-axial direction as the priority direction. Otherwise, the processing proceeds to step S2610 and the CPU 201 determines the Y-axial direction as the priority direction.

In the case of the window in FIG. 23, since the total field area located in the X-axial direction is larger than the total field area located in the Y-axial direction, the X-axial direction is given the priority.

In step S2611, fields are sorted as is with the first exemplary embodiment.

In other words, biased distribution of the fields in the sub-windows is determined, and the priority order of input (i.e., X-axial direction or Y-axial direction) is determined. The coordinate management method and the input focus movement method according to the present exemplary embodiment are similar to those described in the first exemplary embodiment.

The above-described processes are sequentially repeated for a number of times that equals the number of the sub-windows until all the input order tables are completed. The destination of the tab key is determined according to the determined input order.

The above-described example is a case where fields in a sub-window are controlled. The same method can be applied to the sub-windows by dividing the display areas of the display 204 into division areas and using a ratio of the area of the sub-windows included in the division areas.

According to the above-described exemplary embodiment, the priority is determined according to the total area of the fields in the division area. However, the number of fields in the divided area can be also used for determining the priority.

Further, by allowing a user to select between the algorithms according to the first and the seventh exemplary embodiments, the method for automatically determining the input order can be selected accordingly.

Although various exemplary embodiments have been described above, the present invention is not limited to the above-described exemplary embodiments, and various modifications can be applied to the embodiments so long as the modifications are within the scope of the present invention.

The present invention can be also achieved by supplying a recording medium (or a storage medium) for recording a software program which is configured to realize a function of the above-described exemplary embodiments, to a system or an apparatus and reading out and executing the program code stored in the recording medium by a computer (or CPU or MPU) of the system or the apparatus. In this case, the program code read out from the recording medium itself realizes the functions of the above-described exemplary embodiments and the recording medium which stores the program code also falls within the scope of the present invention.

A function of the above-described embodiments is realized not only when the computer executes the program code. For example, an OS or the like, which runs on a computer, can execute a part or whole of the actual processing based on an instruction of the program code so that a function of the above-described embodiments can be achieved.

Further, a program code read out from a recording medium can be written in a memory provided in a function expansion card of a computer or a function expansion unit connected to the computer. Based on an instruction of the program, the CPU of the function expansion card or a function expansion unit can execute a part or all of the actual processing. The functions of the aforementioned exemplary embodiments can be realized in this manner.

When the present invention is applied to the above-described recording medium, a program code corresponding to the above-described flowcharts will be stored in the recording medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-111516 filed Apr. 22, 2008, which is hereby incorporated by reference herein in its entirety.

What is claimed is:

1. An information processing apparatus comprising:
an evaluation unit configured to obtain priority for each arranged component according to attribute information given to the arranged component, and
a determination unit configured to obtain an order used for selecting the arranged component according to the priority.

2. An information processing apparatus comprising:
an evaluation unit configured to obtain priority for each arranged component according to attribute information and position information given to the arranged component;
a determination unit configured to obtain an order used for selecting the arranged component according to the priority, and
a selection unit configured to select the arranged component in the order determined by the determination unit.

3. The information processing apparatus according to claim 1, wherein the evaluation unit changes priority given to the attribute information based on display content information.

4. The information processing apparatus according to claim 2, wherein the evaluation unit gives higher priority to the arranged component located at a smaller distance from a reference point using the position information.

5. The information processing apparatus according to claim 2, wherein the evaluation unit gives higher priority to the arranged component located at a smaller weighted distance from a reference point using the position information.

6. The information processing apparatus according to claim 4, wherein the position of the reference point is changed based on display content information.

7. The information processing apparatus according to claim 4, wherein the arranged component is at least one of an input item, a button, and a sub-window.

8. The information processing apparatus according to claim 2, further comprising a counting unit configured to divide an area in a sub-window into a plurality of areas and counting a number of arranged components included in the divided area using the position information, and
wherein the evaluation unit changes the priority according to a result obtained by the counting unit.

9. The information processing apparatus according to claim 2, further comprising an input instruction unit configured to perform input instruction for changing the position information.

10. The information processing apparatus according to claim 9, wherein at least one of user information, a client department, and usage is input by the input instructing unit.

11. The information processing apparatus according to claim 9, further comprising a change unit configured to change, when a diagnosis and treatment department is input as an input instruction of the input instruction unit, the position information according to the diagnosis and treatment department.

12. An X-ray imaging apparatus comprising:
an evaluation unit configured to obtain priority of each arranged component using attribute information including at least any one of subject information, imaging portion information, imaging condition information, and image processing parameter information given to the arranged component and position information;
a determination unit configured to obtain an order used for selecting the arranged component based on a result obtained by the evaluation unit; and
a selection unit configured to select the arranged component in the order determined by the determination unit,
wherein the subject information has higher priority for the evaluation unit in an imaging preparation state and the image processing parameter information has higher priority for the evaluation unit in an imaging screen confirmation state.

13. The X-ray imaging apparatus according to claim 12, wherein the subject information is patient information.

14. The X-ray imaging apparatus according to claim 12, further comprising a changing unit configured to change the attribute information and the position information based on an intended use of the X-ray imaging.

15. A control method comprising:
evaluating priority of each arranged component according to attribute information given to the arranged component, and
determining an order used for selecting the arranged component according to the result obtained by the evaluation.
